(19) United States
(12) Patent Application Publication
(10) Pub. No.: US 2007/0089691 A1
(43) Pub. Date: Apr. 26, 2007

(54) Foot covering for animals

(76) Inventor: Jacqueline J. Hendy, Bowie, MD (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/257,719

(22) Filed: Oct. 25, 2005

(51) Int. Cl. A01K 13/00

(52) U.S. Cl. 119/850

(57) ABSTRACT

A foot covering for an animal. The foot covering may comprise a substantially elastic shell defining an interior cavity, which may be configured to receive a foot of the animal. The shell may comprise an exterior surface, an interior surface, and at least one toe section configured to receive at least one toe of the animal. Also, the shell may be configured to form-fit the foot of the animal.

### BACKGROUND OF THE INVENTION

Many owners of dogs and other small animals, by choice or necessity, allow their animals to exercise outdoors. Often, the animals track mud, snow, dirt and other various contaminants back into the owner's dwelling upon returning from a trip outside. At best, this requires the owner to perform otherwise unnecessary cleaning. At worst, it can cause permanent staining. The problem can be particularly acute in the winter months and during rainy periods when the animals are more likely to encounter snow and mud outdoors.

It is known to place shoes or other coverings over the feet of dogs and other animals before allowing them outdoors. Existing shoes, however, create additional inconvenience. Many existing shoe designs are fastened to an animal with straps or tabs held in place by hook and loop fasteners or adhesive. This makes it difficult to put the shoes on the animal. Also, straps or tabs tend to fall off or become unfastened, causing the animal to lose the shoes altogether. These and other existing shoe designs are made from cloth or hard rubber materials that does not match the form of the animal's paws and lower legs. This may cause discomfort to the animal, making it reluctant to wear the shoes.

Accordingly, there is a need for a foot covering for animals that can be securely fastened to an animal and is form-fitted to the animal's foot and/or lower leg.

### BRIEF SUMMARY OF THE INVENTION

In accordance with various embodiments, there is provided a foot covering for an animal. The foot covering may comprise a substantially elastic shell defining an interior cavity, which may be configured to receive a foot of the animal. The shell may comprise an exterior surface, an interior surface, and at least one toe section configured to receive at least one toe of the animal. Also, the shell may be configured to form-fit the foot of the animal.

### BRIEF DESCRIPTION OF THE FIGURES

Embodiments of the present disclosure are described below by way of example in conjunction with the following figures, wherein:

FIG. 1 is a three dimensional view of a foot covering according to various embodiments;

FIG. 2 is a top-down view of a foot covering according to various embodiments;

FIG. 3 is a frontal view of a foot covering according to various embodiments;

FIG. 4 is a side view of a foot covering according to various embodiments; and

FIG. 5 is a three dimensional view of an animal wearing a set of foot coverings according to various embodiments.

### DETAILED DESCRIPTION OF THE INVENTION

As used herein, the term “elastic” refers to any material capable of recovering its size and shape after a deformation. As used herein, an object that is “form-fitting” or “form-fit” to a second object substantially matches the contours of the second object.

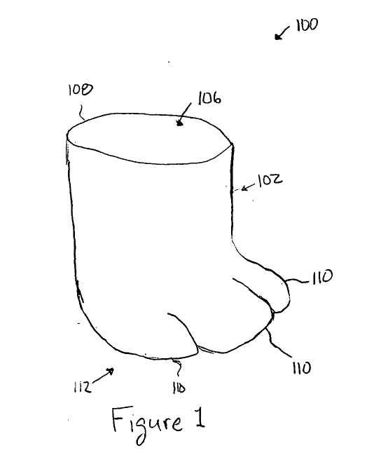

FIGS. 1-3 show an animal foot covering according to various embodiments of the present invention. The foot covering may be used with various kinds of domestic animals including, for example, dogs, cats, etc. The covering may comprise a substantially elastic shell 100 defining an interior cavity configured to receive a foot of an animal. The shell 100 may comprise an exterior surface 102 and an interior surface 106, with at least a portion of the interior surface 106 facing the interior cavity. A rim 108 of the shell 100 may define an interface between the exterior surface 102 and the interior surface 106. In various embodiments, the rim 108 may be rolled or beaded, which may make it easier to place the shell 100 on the animal. A sole portion 112 of the shell 100 may positioned opposite the rim 108.

The shell 100 may also include one or more toe sections 110 for receiving the animal's toes. Each of the toe sections 110 may correspond to one toe of the animal. In various embodiments, one or more of the toe sections 110 may correspond to multiple toes of the animal. For example, a dog's middle two toes may correspond to one large toe section 110, as shown in FIG. 1. It will be appreciated that the number and location of the toe sections 110 may depend on the number and location of the animal's toes. The shell 100, in various embodiments, may be inexpensive enough to be disposable.

In various embodiments, the shell 100 may be substantially formed from any elastic material, such as, for example, an elastomer. Non-limiting examples of suitable elastic materials include natural latex rubber as well as synthetic materials, such as, Polychloroprene (Neoprene), Styrene butadiene, Styrene ethylene butadiene, Nitrile rubber, vinyl, etc. The elastic material may be porous and/or substantially water impermeable. A porous material may allow the animal's perspiration to escape, making the shell 100 more comfortable for the animal to wear. A substantially water-impermeable material may prevent water and other contaminants from entering the shell 100 and contacting the animal's foot.

In various embodiments, a lubricant may be provided on the interior surface 106 and/or the exterior surface 102 of the shell 100. The lubricant may make it easier to place and remove the shell 100 on the animal's feet. The lubricant may include any suitable lubricating material including, for example, oil, corn starch, other powders, etc. Also, in other various embodiments, the lubricant may include a polymer coating present on the interior surface 106 of the shell 100, the exterior surface 102 of the shell 100, or both.

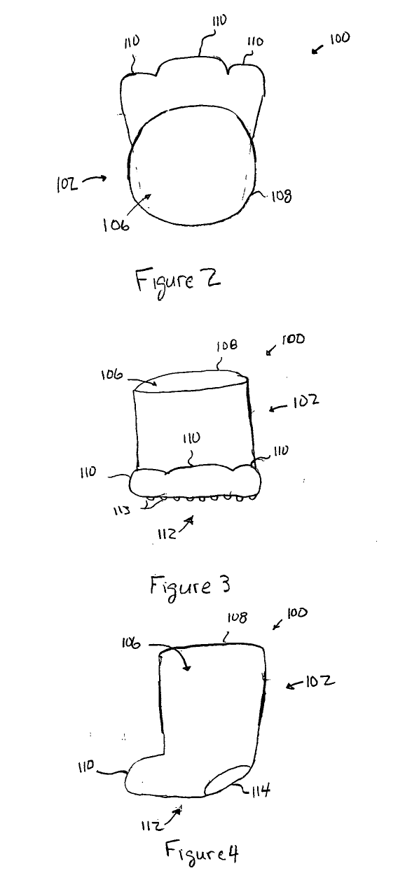

In various embodiments, the shell 100 may be between about 3 and about 6 mils in thickness. The thickness of the shell 100 may be substantially uniform over its entire area, or may vary. For example, it may be desirable for certain portions of the shell 100, such as, for example, the sole 112, to be thicker than other portions, such as, for example, the toe sections 110. In addition, the shell 100 may include various pockets 114 as described below. Also, in non-limiting embodiments, all or a portion of the outer surface 102 may include knobs 113 or other texture, as shown in FIG. 3. The knobs 113 or other texture may help the animal maintain traction on slippery surfaces. In various embodiments, the knobs 113 or other texture may be positioned on a portion of the outer surface 102 corresponding to the sole 112.

FIG. 4 shows a side view of the shell 100, with a portion of the shell 100 cut away to show the sole 112 and pocket 114. The pocket 114 may provide cushioning to the animal's foot. The pocket 114 is shown opposite the toe section 110 to provide cushioning to the animal's heel. It will be appreciated, however, that similar pockets may be placed at other locations along the interior surface 106 in addition to or instead of pocket 114 to cushion other portions of the animal's foot or leg. The pocket 114 itself, in one non-limiting embodiment, may enclose a hollow cavity that may be filled with any soft material including, for example, air, water, saline, gel, etc. In other non-limiting embodiments, the pocket 114 may be an area of the shell 100 with increased thickness.

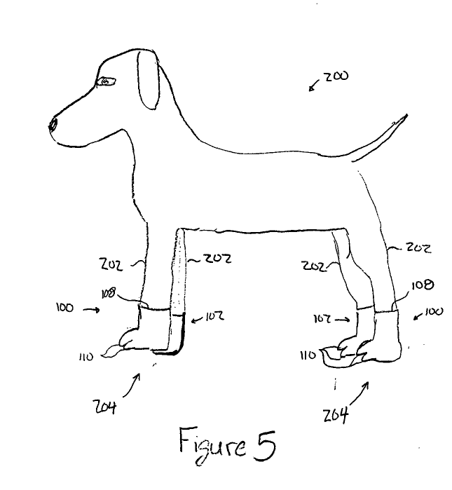

FIG. 5 shows an exemplary animal 200 wearing shells 100 according to various embodiments. The feet of the animal 200 may be placed within the shells 100 with the rims 108 positioned around the animal's legs 202 or the upper portions of the feet of the animal 200. The toes of the animal 200 may be positioned within toe portions 110. When worm, the shells 100 may form-fit the feet and/or legs 202 of the animal 200. This may secure the shells 100 to prevent them from coming off during use. Also, the form-fitting nature of the shells 100 may allow the animal 200 greater use of its feet and legs 202.

In one non-limiting embodiment, the shells 100 may be placed on an animal's feet by first stretching the shell 100 to a size greater than the animal's foot 204 and/or lower leg 202. The stretched shell 100 may be slid over a foot and/or lower leg 202 of the animal 200 and then released. When the shell 100 is released, it may contract, securing itself to the foot and/or lower leg 202 of the animal. The result may be a snug, form-fitted relationship between the shell 100 and the foot of the animal 200. The shell 100 may be removed from the foot of the animal 200 by stretching the shell 100 to a size greater than the foot and/or lower leg 202 of the animal 200 and removing the shell 100 from the animal. It will be appreciated that in various embodiments, the shell 100 may then be thrown away.

While several embodiments of the invention have been described, it should be apparent that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention as defined by the appended claims.

I claim:

1. A foot covering for an animal, the foot covering comprising:
a substantially elastic shell defining an interior cavity, the interior cavity configured to receive a foot of the animal, the shell comprising:
an exterior surface;
an interior surface; and
at least one toe section configured to receive at least one toe of the animal; and
wherein the shell is configured to form-fit the foot of the animal.

2. The foot covering of claim 1, wherein the shell further comprises a second toe section configured to receive at least a second toe of the animal.

3. The foot covering of claim 1, wherein the shell is between about 3 mils and about 6 mils in thickness.

4. The foot covering of claim 1, wherein the shell is made from an elastic material.

5. The foot covering of claim 4, wherein the elastic material comprises latex rubber.

6. The foot covering of claim 4, wherein the elastic material comprises at least one of the following: vinyl, and nitrile rubber.

7. The foot covering of claim 1, wherein a lubricant is present on at least the interior surface.

8. The foot covering of claim 7, wherein the lubricant comprises a powder.

9. The foot covering of claim 8, wherein the powder comprises a cornstarch powder.

10. The foot covering of claim 7, wherein the lubricant comprises a polymer coating.

11. The foot covering of claim 1, wherein the shell further comprises a rim defining an interface between the interior surface and the exterior surface.

12. The foot covering of claim 11, wherein the rim is beaded.

13. The foot covering of claim 11, wherein the shell further comprises a sole portion positioned opposite the rim, wherein a thickness of the shell at a sole portion is greater than a thickness of the shell at the at least one toe section.

14. The foot covering of claim 1, wherein a cushion portion of the shell configured to be placed in contact with at least a portion of the animal's foot further defines a second cavity, and wherein a cushion material is present in the second cavity.

15. The foot covering of claim 14, wherein the cushion material is a gel.

16. The foot covering of claim 14, wherein the cushion material comprises at least one of the following: air, water and a saline solution.

17. The foot covering of claim 1, wherein at least a portion of the shell is porous.

18. The foot covering of claim 1, wherein at least a portion of the shell is substantially impermeable to water.

19. The foot covering of claim 1, wherein at least a portion of the exterior surface is textured.

20. The foot covering of claim 1, wherein at least a portion of the exterior surface comprises knobs.
